(19) United States
(12) Patent Application Publication
(10) Pub. No.: US 2018/0334311 A1
(43) Pub. Date: Nov. 22, 2018

(54) DENTAL FLOSS DISPENSER

(71) Applicant: Cheryl Pai Bittner, Fort Lauderdale, FL (US)

(72) Inventor: Cheryl Pai Bittner, Fort Lauderdale, FL (US)

(21) Appl. No.: 15/597,838

(22) Filed: May 17, 2017

(51) Int. Cl. B65D 83/08; A61C 15/04; A47K 10/42; B65H 45/24

(52) U.S. Cl. CPC B65D 83/0805; A61C 15/043; B65H 45/24; A47K 10/421; A61C 15/041

(57) ABSTRACT

A dental floss and post-floss cleaning system including a plurality of floss-and-post-floss-cleaning assemblies; and a dental floss and wiping implement dispenser. The dispenser may have a dispenser cavity and may be configured to hold, within the dispenser cavity, and dispense, out of the dispenser cavity, the plurality of floss-and-post-floss-cleaning assemblies. Each of the plurality of floss-and-post-floss-cleaning assemblies may be configured as a single-use assembly and each may include a single-use wiping implement made of a flexible and absorbent material suitable for wiping post-floss food particles and saliva; and a corresponding pre-cut dental floss strand having a predetermined length and being removeably affixed to the single-use wiping implement.

### FIELD OF THE INVENTION

The present invention relates generally to dental floss, and, more particularly, relates to a dental floss dispenser for dispensing flossing assemblies, each flossing assembly including a dental floss strand removeably affixed to a wiping implement.

### BACKGROUND OF THE INVENTION

It is well understood that flossing is an important aspect of dental hygiene. Flossing between teeth cleans areas where a toothbrush cannot reach, thereby preventing plaque build-up on teeth. Plaque is bacteria that feeds on leftover food particles and sugar and releases an acid that can eat away at the outer shell of teeth and cause cavities. Further, plaque that is not removed by brushing and cleaning between teeth eventually hardens into a rough substance called tarter, which causes gum disease and can only be removed by a dental professional.

Unfortunately, many people do not floss as a daily part of their dental hygiene practice. The American Dental Association recommends cleaning between teeth at least once every day. Some of the common reasons that people do not floss their teeth include the lack of knowledge as to how to floss properly, lacking the time to floss, and not having the flossing tools readily available to floss after meals.

Dental floss is conventionally available as a spool of floss material, typically a strand made of a synthetic polymer compound, such as nylon, housed in a small plastic container. The plastic container typically includes a cutting tool. Users may pull the strand from the spool and use the cutting tool to select a length for the cut strand. Unfortunately, users will often select a length that is either too short or too long, which can lead to improper flossing and waste.

Further, flossing can be a messy endeavor, resulting in loosened food particles and saliva. Often, users are limited to flossing in areas where cleaning supplies are readily available, such as a bathroom. However, this further limits the convenience factor associated with flossing, generally tending to discourage daily flossing practices.

In addition, consumers of floss can be placed into generally two categories, namely, individual consumers and the dental industry. With regard to floss packaging and post-floss clean-up, there are disadvantages in the prior art for each of said categories of floss consumers.

For individual consumers, due to saliva, bacteria, food debris, blood, etc. that can be produced during flossing it normally requires access to a sink, i.e. a bathroom, to clean up after flossing. As such, the location for flossing and compliance for daily flossing is negatively impacted.

For the dental industry, flossing is a standard activity conducted by licensed dental professionals (dentists, hygienists, assistants) and performed on most patients. Such professionals wear latex gloves to protect themselves during the treatment of each patient, and the equipment utilized is typically discarded or sterilized for the next patient, with exception of the floss dispenser. The floss dispenser is handled by “dirty” gloved hands during each patient's exam. With existing floss dispensing devices, the dental professional is required to hold the floss dispenser, pull the floss out a length of floss, and cut the floss. Because the floss dispenser is reused patient after patient there is a real possibility of transfer of infectious germs from patient to patient.

Therefore, a need exists to overcome the problems with the prior art as discussed above.

### SUMMARY OF THE INVENTION

The invention provides a dental floss dispenser that overcomes the herein-aforementioned disadvantages of the heretofore-known devices and methods of this general type.

With the foregoing and other objects in mind, there is provided, in accordance with the invention, a dental floss and post-floss cleaning system including a plurality of floss-and-post-floss cleaning assemblies, each configured as a single-use assembly, and each including a single-use wiping implement made of a flexible and absorbent material suitable for wiping post-floss food particles and saliva; and a corresponding pre-cut dental floss strand having a predetermined length and being removably affixed to the single-use wiping implement. The dental floss and post-floss cleaning system also includes a dental floss and wiping implement dispenser having a dispenser cavity. The dental floss and wiping dispenser is configured to hold, within the dispenser cavity, and dispense, out of the dispenser cavity, the plurality of floss-and-post-floss-cleaning assemblies.

In accordance with another feature, in one embodiment of the present invention, the single-use wiping implement is formed as one of a tissue paper and a gauze pad, each of the one of the tissue paper and the gauze pad corresponding to and affixed to a single pre-cut dental floss strand.

In accordance with a further feature, in one embodiment of the present invention, the plurality of floss-and-post-floss cleaning assemblies are disposed in an overlapping configuration within the dispenser cavity.

In accordance with yet another feature, in one embodiment of the present invention, each of the plurality of floss-and-post-floss cleaning assemblies is arranged in a stack within the dispenser cavity such that the pre-cut dental floss strands are disposed between the single-use wiping implements.

In accordance with another characteristic, in one embodiment of the present invention, the dental floss and wiping implement dispenser includes a top wall defining a dispensing opening through which each of the floss-and-post-floss cleaning assemblies are individually withdrawn from the dispenser cavity.

In accordance with another feature, in one embodiment of the present invention, the dental floss and wiping implement dispenser is formed as a dispensing carton with a top wall defining a dispensing opening through which the single-use wiping implements and corresponding precut dental floss strands are individually withdrawn from the dispensing carton; two pairs of opposing sidewalls; and a bottom wall, opposite the top wall.

In accordance with a further feature, in one embodiment of the present invention, the dental floss and wiping implement dispenser defines a dispensing opening; each of the single-use wiping implements are discrete wiping implements that are sequentially disposed within the dispenser cavity, with each said discrete wiping implement overlapping an adjacent discrete wiping implement to form a stack of discrete wiping implements; and each of the discrete wiping implements having the corresponding pre-cut dental floss strand affixed thereto both within the dispenser cavity and upon withdrawal outside of the dispenser cavity.

In accordance with yet another feature, in one embodiment of the present invention, the dental floss and wiping implement dispenser defines a dispensing opening; and each of the single-use wiping implements are discrete wiping implements sequentially disposed within the dispenser cavity. Each said discrete wiping implement is releasably attached directly to an adjacent discrete wiping implement, such that a first discrete wiping implement, upon withdrawal through the dispensing opening, pulls a portion of a subsequent adjacent discrete wiping implement through the dispensing opening.

In accordance with another characteristic, in one embodiment of the present invention, each of the floss-and-post-floss cleaning assemblies are interfolded in a stack within the dispenser cavity such that a leading wiping implement of the stack lifts a portion of an adjacent trailing wiping implement of the stack upon withdrawal of the leading wiping implement through a dispensing opening defined by the dental floss and wiping implement dispenser.

In accordance with another feature, in one embodiment of the present invention, for each of the plurality of floss-and-post-floss-cleaning assemblies, the pre-cut dental floss strand is affixed to the single-use wiping implement by an adhesive.

In accordance with a further feature, in one embodiment of the present invention, each of the pre-cut dental floss strands removeably affixed to the single-use wiping implement includes two opposing end portions; and one of the two opposing end portions is a free gripping end portion that is not attached to the single-use wiping implement.

Also in accordance with the invention, a dental floss and post-floss cleaning system is disclosed, including a plurality of floss-and-post-floss-cleaning assemblies, and a dental floss and cleaning sheet dispenser including a top wall defining a dispensing opening and configured to hold and dispense, through the dispensing opening, the plurality of floss-and-post-floss-cleaning assemblies. Each of the plurality of floss-and-post-floss-cleaning assemblies includes a discrete cleaning sheet made of a flexible and absorbent material; and a corresponding pre-cut dental floss strand affixed to the discrete cleaning sheet, the plurality of floss-and-post-floss cleaning assemblies being arranged as a stack such that each discrete cleaning sheet, along with the affixed corresponding pre-cut dental floss strand, is sequentially removable from the dispenser through the dispensing opening.

In accordance with another feature, in one embodiment of the present invention, the discrete cleaning sheet is one of a tissue paper and a gauze pad.

In accordance with a further feature, in one embodiment of the present invention, each of the plurality of floss-and-post-floss cleaning assemblies is arranged in a stack of discrete cleaning sheets, such that each discrete cleaning sheet is disposed on top of an adjacent discrete cleaning sheet with one pre-cut dental floss strand between each discrete cleaning sheet.

In accordance with yet another feature, in one embodiment of the present invention, each of the floss-and-post-floss cleaning assemblies are interfolded in a stack of discrete cleaning sheets, such that a leading discrete cleaning sheet of the stack lifts a portion of an adjacent discrete cleaning sheet of the stack upon withdrawal of the leading discrete cleaning sheet through the dispensing opening.

In accordance with another characteristic, in one embodiment of the present invention, for each of the plurality of floss-and-post-floss-cleaning assemblies, the pre-cut dental floss strand is affixed to the discrete cleaning sheet by an adhesive.

In accordance with another feature, in one embodiment of the present invention, the dental floss and cleaning sheet dispenser is formed as a tissue box.

Also in accordance with the invention, a dental floss and post-floss cleaning system is disclosed, including one of a tissue paper and a gauze pad with a pre-cut dental floss strand removably affixed thereto with an adhesive; and a dispensing body configured to dispense the one of the tissue paper and the gauze pad together with the adhered pre-cut dental floss strand.

In accordance with a further feature, in one embodiment of the present invention, the dispensing body includes a dispensing carton defining a dispensing opening through which the one of the tissue paper and the gauze pad, together with the adhered pre-cut dental floss strand, is removable from the dispensing carton.

In accordance with yet another feature, in one embodiment of the present invention, the dispensing carton houses a plurality of tissue papers or gauze pads each with a pre-cut dental floss strand removeably affixed thereto, the plurality of tissue papers or gauze pads being arranged in a sequential stack within the dispensing carton so as to be sequentially and individually removable from the dispensing carton through the dispensing opening.

Although the invention is illustrated and described herein as embodied in a dental floss dispenser, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the dental floss dispenser.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective downward-looking view of an exemplary dental floss dispenser in accordance with the present invention;

FIG. 2 is a perspective downward-looking view of a single-use flossing assembly, removed from the dental floss dispenser of FIG. 1, in accordance with the present invention;

FIG. 3 is a perspective side view of a stack of single-use flossing assemblies, removed from the dental floss dispenser of FIG. 1, in accordance with the present invention;

FIG. 4 is a fragmentary, exploded, cross-sectional view of the stack of single-use flossing assemblies to be dispensed out of the dental floss dispenser of FIG. 1, in accordance with the present invention;

FIG. 5 is a schematic, cross-sectional view of an alternative embodiment of a stack of single-use flossing assemblies within the dental floss dispenser of FIG. 1, in accordance with the present invention;

FIG. 6 is a perspective downward-looking view of yet another exemplary alternative embodiment of a stack of single-use flossing assemblies, to be dispensed out of the dental floss dispenser of FIG. 1, in accordance with the present invention; and

FIG. 7 is a perspective downward-looking view of another exemplary embodiment of a single-use flossing assembly with an adhesive tape, removed from the dental floss dispenser of FIG. 1, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient dental floss dispenser that also includes wiping implements for clean-up after flossing, in other words, post-floss clean-up. Embodiments of the invention provide for the dental floss dispenser to house a stack of single-use flossing assemblies that each includes a pre-cut strand of floss removeably affixed/attached to each wiping implement. The availability of the wiping implement solves the location problem associated with existing methods/devices for flossing, by not requiring access to a sink. Accordingly, flossing can be performed in the home outside the bathroom, in a car, in the office, etc. Secondarily the problem of disposing of the floss after use is solved by being able to be wrapped in the wiping implement after use. Furthermore, by packaging pre-cut floss together with the wiping implement the dental professional is not required to touch the dispenser, resulting in the above-referenced potential for contamination. The same advantages of reducing/eliminating the potential for cross contamination would apply to individual consumers, as well, where more than one person in the household uses the same floss dispenser.

In addition, embodiments of the invention provide that each pre-cut strand of floss be removeably affixed to each wiping implement by an adhesive, such as, an adhesive tape. In other embodiments of the present invention, the wiping implement may be formed as one of a tissue paper, and a 2×2 gauze pad.

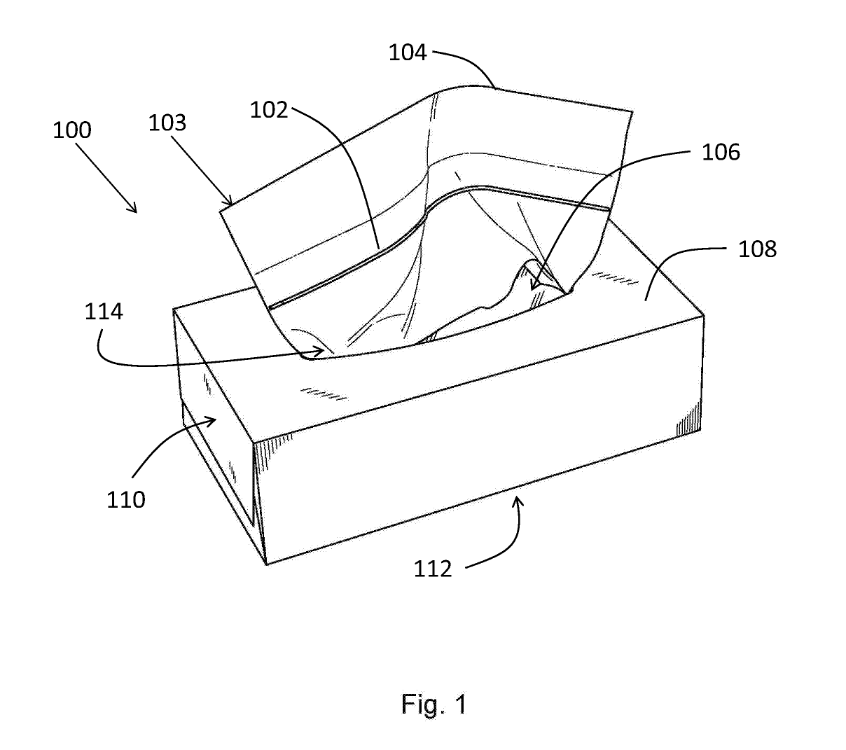

Referring now to FIGS. 1-3, one embodiment of the present invention is shown in several perspective views. FIGS. 1-3 show several advantageous features of the present invention, but, as will be described below, the invention can be provided in several shapes, sizes, combinations of features and components, and varying numbers and functions of the components. The first example of a dental floss and post-floss cleaning system, as shown in FIG. 1, includes a dental floss and wiping implement dispenser 100. Such dispenser 100 may also be considered a dental floss and cleaning sheet dispenser 100.

The dispenser 100 should be configured to house and dispense the floss strands 102 and wiping implements 104 for flossing and for post-floss clean-up. In preferred embodiments, the wiping implements 104 and floss strands 102 may be formed as a plurality of flossing assemblies 103. More specifically, the plurality of flossing assemblies 103 may be configured as single-use assemblies and may be considered a plurality of floss-and-post-floss cleaning assemblies 103, which will be described herein below in more detail.

In one embodiment, the dispenser 100 defines a dispenser cavity 106 for housing the plurality of floss-and-post-floss cleaning assemblies 103. Stated another way, the dispenser 100 may be configured to hold, within the dispenser cavity 106, and dispense, out of the dispenser cavity 106, the plurality of floss-and-post-floss cleaning assemblies 103. The dispenser cavity 106 may be defined by the exterior walls of the dispenser 100. The exterior walls may be plain in appearance, as shown in FIG. 1, or may include decorative elements observable from the outside environment. The number of floss-and-post-floss cleaning assembles 103 housed within the dispenser 100 can by any number.

The dispenser 100 may, in some embodiments, be formed similar to a tissue box, as one embodiment of the wiping implements 104 is facial tissue paper. In another embodiment, the dispenser 100 may be considered a dispensing carton with a top wall 108, two pairs of opposing sidewalls 110, and a bottom wall 112 opposite the top wall 108. The top wall 108 may define a dispensing opening 114 sized for individual withdrawal of each of the plurality of floss-and-post-floss cleaning assemblies 103. The dispensing opening 114 may provide a through-opening, through which each of the single-use floss-and-post-floss cleaning assemblies 103 may be individually withdrawn from the dispenser cavity 106.

The two pairs of opposing sidewalls 110 may be formed as four (4) laterally enclosing sidewalls disposed on each of the four (4) sides of the dispenser 100, with the top wall 108 and the bottom wall 112 substantially enclosing the dispenser 100 from the top and bottom. In other embodiments, the dispenser 100 may be laterally enclosed by a singular continuous sidewall.

In some embodiments, the dispenser 100 may be formed as a cardboard box. In other embodiments, the dispenser 100 may be formed as a plastic package. In yet other embodiments, the dispenser 100 may be made out of other materials, but should still be configured to house and facilitate removal therefrom of the plurality of floss-and-post-floss cleaning assemblies 103. In preferred embodiments, the dispenser 100 facilitates individual removal therefrom of each the plurality of floss-and-post-floss cleaning assemblies 103.

In some embodiments, the dispenser 100 may be rectangular-shaped. In other embodiments, the dispenser 100 may be circular-shaped. In yet other embodiments, the dispenser 100 may be formed as other shapes and sizes. Importantly, the dispenser 100 should be configured to house and dispense each of the plurality of floss-and-post-floss cleaning assemblies 103.

In one embodiment, each of the floss-and-post-floss cleaning assemblies 103 includes a single-use wiping implement 104 and a corresponding single-use pre-cut dental floss strand 102. The pre-cut dental floss strand 102 may be removeably affixed to the single-use wiping implement 104 so as to provide a single-use floss-and-post-floss cleaning assembly 103. The removable coupling of the wiping implement 104 to the floss strand 102 will be discussed herein in more detail below.

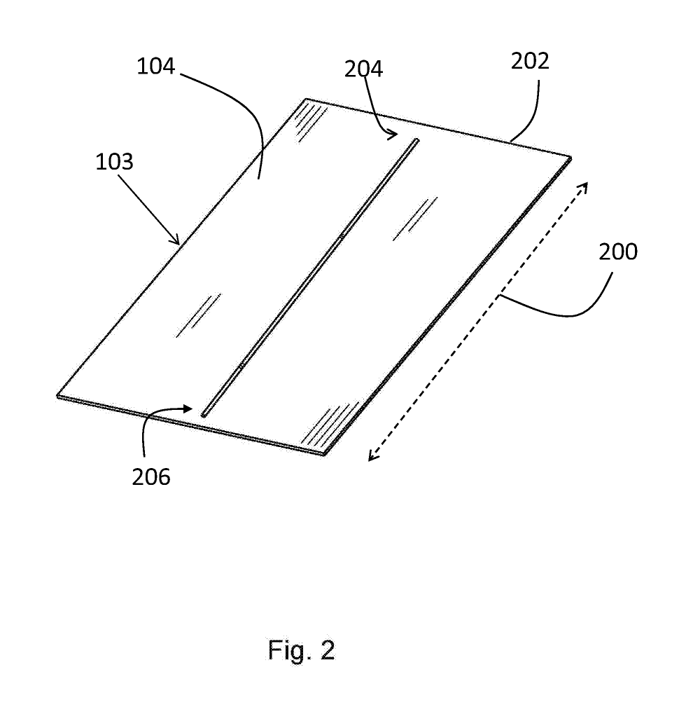

As used herein, the term “pre-cut” is intended to indicate that the dental floss strand 102 is cut at the manufacturing stage and provided to the user already cut having a predetermined length 200, as shown in FIG. 2, so as to ensure optimal flossing length of the dental floss strand 102. In one embodiment, the predetermined length 200 may be 18 inches, as recommended by the American Dental Association. In other embodiments, the predetermined length 200 may be greater or less than 18 inches, but should still be sized for proper flossing.

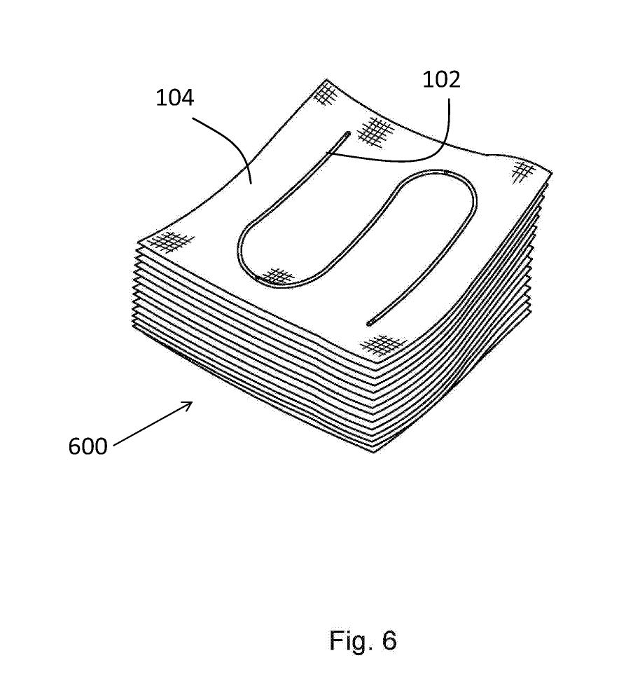

In one embodiment, the length 200 of the pre-cut dental floss strand 102 may correspond to a length of the wiping implement 104, as shown in FIG. 2. In other words, the pre-cut dental floss strand 102 may be the same or slightly smaller than the length of the wiping implement 104. In another embodiment, the length 200 of the pre-cut dental floss strand 102 is longer than a length of the wiping implement 104 and may, therefore, be coupled to the wiping implement 104 in an overlapping manner, as depicted in FIG. 6. In other words, the pre-cut dental floss strand 102 may be looped, curved, or formed as a spiral on the wiping implement 104, such that the dental floss strand 102 does not extend beyond the peripheral edges 202 of the wiping implement 104.

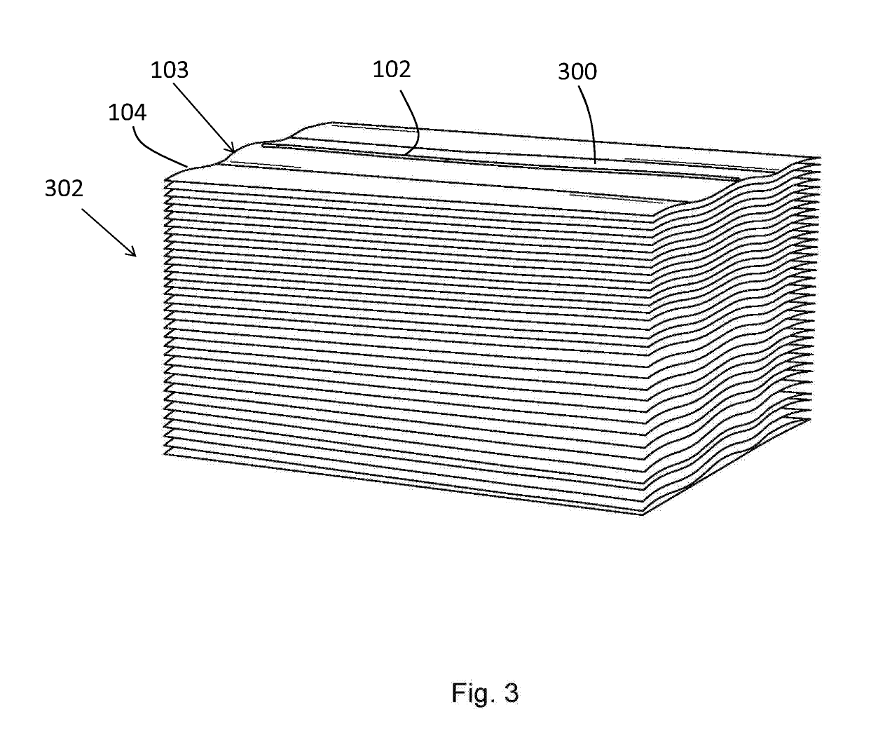

In other embodiments, some portions of the dental floss strand 102 may extend beyond the peripheral edges 202 of the wiping implement 104, such as, for example, a nominal end-portion that provides a free gripping end for the user to grip the dental floss strand 102 for removal from the wiping implement 104. Preferably, the arrangement of the dental floss strand 102 should not be susceptible to tangling of the strand 102, or become overly messy and cumbersome within the dispenser 100. In a preferred embodiment, the dental floss strand 102 lays generally flat on a planar surface 300 of the wiping implement 104 substantially, or entirely, along its length 200 (when in its stored configuration within the dispenser 100, as illustrated in FIG. 3). Accordingly, a thorough adherence or coupling of the dental floss strand 102 to the wiping implement 104 can be provided along its length 200.

The materials and construction of dental floss is generally known in the art and will therefore not be described in great detail herein.

The wiping implement 104 may also be considered a cleaning sheet and should be configured to facilitate post-floss clean-up and wiping of food particles and saliva typically produced during flossing. In a preferred embodiment, the wiping implement 104 is made of a flexible and absorbent material suitable for wiping and/or absorbing such post-floss fluid and debris. In one embodiment, the wiping implement 104 is a substantially thin sheet(s) of material suitable for wiping and cleaning. Stated another way, the wiping implement 104 may be formed as one or more layers of a panel of material. In a further embodiment, the wiping implement 104 may be made of a thin fabric material, such as cotton or paper, which may be woven or non-woven. In yet a further embodiment, the wiping implement 104 is disposable and sufficiently flexible for easily wrapping the used floss strand 102 therein for disposal within a trash receptacle.

In one preferred embodiment, the wiping implement 104 is formed as a facial tissue paper. As used herein, the word “facial” used within the term “facial tissue paper” is not intended to limit use of the facial tissue paper to a user's face, but rather describes a type of paper, known in the art, that is generally soft, absorbent, and disposable. In another embodiment, the wiping implement 104 may be made of other types of tissue paper material, such as, for example, a paper towel material or a table napkin-type material.

In another embodiment, the wiping implement 104 is formed as a gauze pad, with the dispenser 100 housing a stack of gauze pads 600, as depicted in FIG. 6. The gauze pad may be formed as a 2 inch by 2 inch gauze pad, known for use in sterile environments, such as hospitals and dentist offices. Other embodiments may provide a gauze pad having different dimensions. Because the dental floss strand 102 affixed to the wiping implement 104 is provided for use within a person's mouth, the wiping implement 104 may, in some embodiments, be a sterile wiping implement 104, configured to be entirely or at least substantially free from bacteria or any other living microorganisms that are undesirable in a user's mouth. Specifically, flossing sometimes results in a small tear in the gums that bleeds through. It may be undesirable to provide the dental floss strand 102 on a wiping implement 104 that may be undesirably contaminated and can enter the user's gum tissue through such tears, potentially causing an infection. In other embodiments, the wiping implement 104 may not be considered sterile.

In one embodiment, the wiping implement 104 may be rectangular-shaped. In another embodiment, the wiping implement 104 may be square-shaped. In yet other embodiments, the wiping implement 104 may be provided in other shapes and sizes.

Still referring primarily to FIGS. 1-3, each of the plurality of floss-and-post-floss cleaning assemblies 103 provides for the dental floss strand 102 to be removeably affixed to the wiping implement 104. As used herein, the terms “affixed” and “attached” are used interchangeably and each of such terms is intended to indicate that the dental floss strand 102 is removeably fastened to, and/or adhered to the wiping implement/cleaning sheet 104 (whether or not “removeably” is expressly used to modify such terms). Stated another way, the terms “affixed” and “attached” are used herein to indicate that the dental floss strand 102 and wiping implement/cleaning sheet 104 are sufficiently coupled to one another so as not to be easily separated when stored in the dispenser 100; but should be separable from one another when the user intentionally applies a force sufficient to separate the strand 102 from the sheet 104 to prepare for flossing and post-floss cleaning.

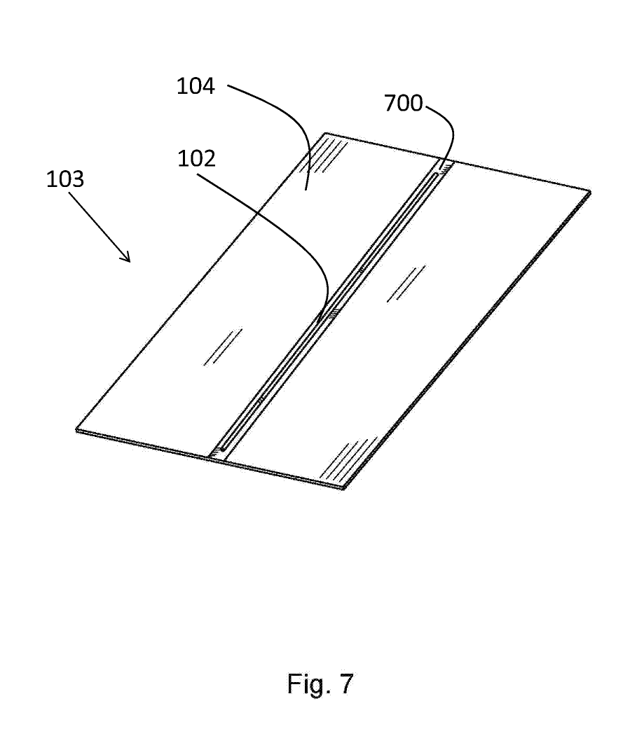

In one embodiment, for each of the plurality of floss-and-post-floss cleaning assemblies 103, the pre-cut dental floss strand 102 may be affixed to the wiping implement 104 by an adhesive 700 (see FIG. 7), such as, for example, a tape, a resin, a glue, a paste, and the like. In some embodiments, the adhesive 700 is a sterile adhesive because, as described herein above, it is desired to provide a clean dental floss strand 102 that will not contaminate the user's mouth. In another embodiment, the adhesive 700 is provided as a human-consumable compound or material. In other words, the adhesive 700 may be safe for human consumption. The adhesive 700 should be configured to adhere the dental floss strand 102 to the wiping implement 104, but also permit the user to intentionally separate the dental floss strand 102 from the wiping implement 104 when desired, so that the user can selectively use the dental floss strand 102 to floss his teeth. At the same time, the adhesive 700 is preferably applied at an amount and a consistency so as to not tear, or otherwise damage a generally thin wiping implement 104, such as, for example, a facial tissue paper. Preferably, the adhesive 700 is also configured so as not to tear, or otherwise damage the wiping implement 104 as the dental floss strand 102 is being removed/separated by the user from the wiping implement 104. Doing so could reduce the wiping effectiveness of the wiping implement 104.

In one embodiment, the pre-cut dental floss strand 102 may be arranged on the wiping implement 104 so as to provide a gripping portion for the user to grip with his fingertips to separate the dental floss strand 102 from the wiping implement 104. In a further embodiment, the dental floss strand 102 includes two opposing end portions 204, 206, with at least one of the two end portions 204, 206 not adhered to the wiping implement 104, so that the user can grip such gripping end portion 204, 206 to pull on the strand 102. In other words, to facilitate easy user removal of the dental floss strand 102 certain portions of the dental floss strand 102 may be loose so that the user can readily grip such portion(s) to remove/pull-on the strand 102. Without this feature, it may be fairly cumbersome in some embodiments for the user to separate the dental floss strand 102 from the wiping implement 104.

In another embodiment, for each of the plurality of floss-and-post-floss cleaning assemblies 103 within the dispenser 100, the pre-cut dental floss strand 102 may be affixed to the wiping implement 104 by the arrangement of the wiping implement 104 within the dispenser 100 (either in addition to, or instead of an adhesive 700). In a further embodiment, for each of the plurality of floss-and-post-floss cleaning assemblies 103 within the dispenser 100, the pre-cut dental floss strand 102 may be affixed to the wiping implement 104 by the wiping implement 104 being folded over the pre-cut dental floss strand 102 to form a type of enclosure or envelope for the dental floss strand 102. In yet a further embodiment, peripheral portions of the wiping implement 104 may be folded over the dental floss strand 102 to secure the dental floss strand 102 to the wiping implement 104. In yet other embodiments, for each of the plurality of floss-and-post-floss cleaning assemblies 103 within the dispenser 100, the pre-cut dental floss strand 102 may be affixed to the wiping implement 104 by other arrangements and configurations, but should still sufficiently couple the pre-cut dental floss-strand 102 to its corresponding wiping implement 104 within the dispenser so as not to be easily separated when stored in the dispenser 100; and so that the user can readily withdraw one single-use floss-and-post-floss cleaning assembly 103 from the dispenser 100 without undesirably disrupting the other floss-and-post-floss cleaning assemblies 103 remaining in the dispenser 100.

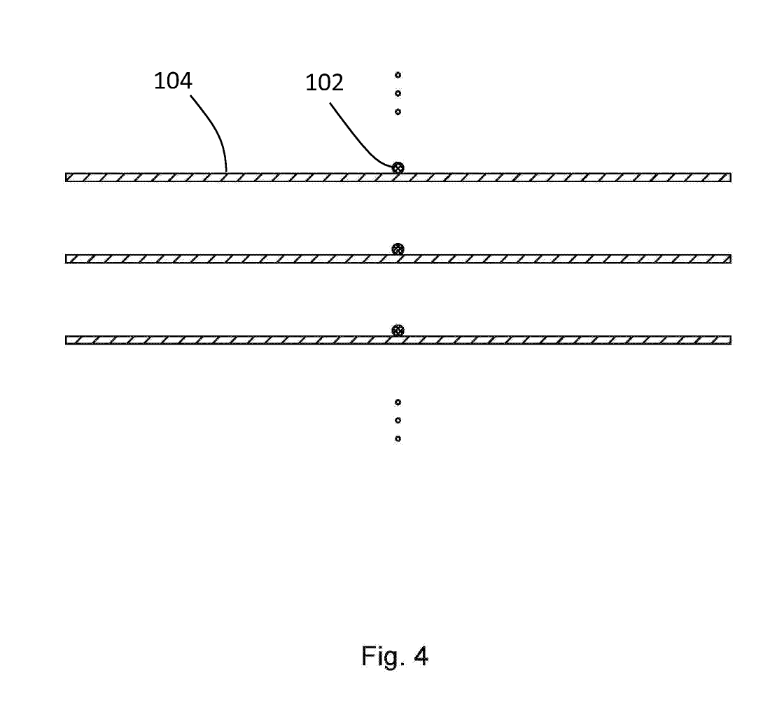

Referring now primarily to FIGS. 1 and 3-5, exemplary embodiments of the arrangement of the plurality of floss-and-post-floss cleaning assemblies 103 within the dispenser 100 will be described. In one embodiment, the plurality of floss-and-post-floss cleaning assemblies 103 are disposed within the dispenser cavity 106 in an overlapping configuration, such as, for example, a stack 302 (FIG. 3). In a further embodiment, the stack 302 of floss-and-post-floss cleaning assemblies 103 is disposed within the dispenser cavity 106 such that each dental floss strand 102 is disposed between the wiping implements 104, in a repeating pattern, as shown in FIG. 4, which is a cross-sectional fragmentary, exploded view of the stack 302. As can be seen in FIG. 4, each wiping implement 104 may be neatly stacked directly on top of the other 104, with dental floss strands 102 in between. Stated another way, each of the single-use wiping implements 104 may be considered a discrete wiping implement 104, with each sequentially disposed within the dispenser cavity 106 and overlapping an adjacent discrete wiping implement 104 to form the stack 302. As used herein, the term “discrete” is defined as individually separate and distinct. Each of the discrete wiping implements 104 within the dispenser cavity 106 should have a corresponding pre-cut dental floss strand 102 affixed thereto (as discussed herein above) and preferably removable outside of the dispenser cavity 106 together as a single unit.

In another embodiment (not shown), the plurality of floss-and-post-floss cleaning assemblies 103 may be arranged as a roll (on a spool) of floss-and-post-floss cleaning assemblies 103, similar to a conventional paper towel roll. In a further embodiment, each of the floss-and-post-floss cleaning assemblies 103 on the roll/spool may be partially separated by perforated edges between adjacent wiping implements 104, rather than the wiping implements 104 being entirely separate from one another, as with the stack 302 illustrated in FIG. 3. The dental floss strands 102 should still preferably be pre-cut dental floss strands 102 arranged on and attached to the perforated wiping implements 104, for easy single-use access.

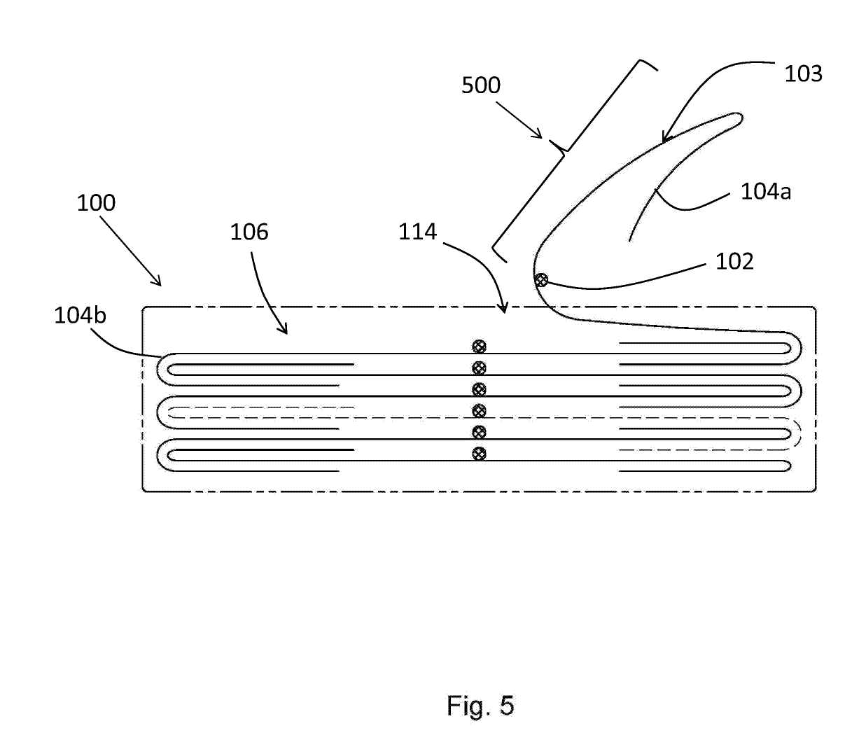

Referring now specifically to FIG. 5, in one embodiment, the plurality of floss-and-post-floss cleaning assemblies 103 are disposed within the dispenser cavity 106 in a releasably attached configuration such that removal of one discrete floss-and-post-floss cleaning assembly 103 pulls and/or lifts a portion of an adjacent discrete floss-and-post-floss cleaning assembly 103 for making the adjacent assembly 103 readily available for a subsequent flossing session. More specifically, as shown in FIG. 5, each of the floss-and-post-floss cleaning assemblies 103 may be sequentially disposed within the dispenser cavity 106, with each discrete wiping implement 104 being releasably attached directly to an adjacent wiping implement 104 such that a first discrete wiping implement 104a, upon withdrawal through the dispensing opening 114, pulls the portion 500 of a subsequent adjacent discrete wiping implement 104b through the dispensing opening 114. Stated yet another way, each of the discrete floss-and-post-floss cleaning assemblies 103 may be interfolded with one another in a sequential manner such that a leading wiping implement 104a lifts the portion 500 of an adjacent trailing wiping implement 104b upon withdrawal of the leading wiping implement 104a through the dispensing opening 114. Accordingly, users can be prompted and encouraged to floss again with a floss-and-post-floss cleaning assembly 103 readily available for subsequent use.

A novel and efficient dental floss dispenser has been disclosed that also includes wiping implements for clean-up after flossing. Embodiments of the invention provide for the dental floss dispenser to house a stack of single-use flossing assemblies that each includes a pre-cut strand of floss removeably affixed/attached to each wiping implement. In addition, embodiments of the invention provide that each pre-cut strand of floss be removeably affixed to each wiping implement by an adhesive, such as, an adhesive tape. In other embodiments of the present invention, the wiping implement may be formed as one of a tissue paper, and a gauze pad.

What is claimed is:

1. A dental floss and post-floss cleaning system comprising:
a plurality of floss-and-post-floss-cleaning assemblies each configured as a single-use assembly and each including:
a single-use wiping implement made of a flexible and absorbent material suitable for wiping post-floss food particles and saliva; and
a corresponding pre-cut dental floss strand having a predetermined length and being removably affixed to a middle portion of the single-use wiping implement; and
a dental floss and wiping implement dispenser having a dispenser cavity and configured to hold, within the dispenser cavity, and dispense, out of the dispenser cavity, the plurality of floss-and-post-floss-cleaning assemblies.

2. The dental floss and post-floss cleaning system in accordance with claim 1, wherein:
the single-use wiping implement is formed as one of a tissue paper and a gauze pad, each of the one of the tissue paper and the gauze pad corresponding to and affixed to a single pre-cut dental floss strand.

3. The dental floss and post-floss cleaning system in accordance with claim 2, wherein:
the plurality of floss-and-post-floss cleaning assemblies are disposed in an overlapping configuration within the dispenser cavity.

4. The dental floss and post-floss cleaning system in accordance with claim 2, wherein:
each of the plurality of floss-and-post-floss cleaning assemblies is arranged in a stack within the dispenser cavity such that the pre-cut dental floss strands are disposed between the single-use wiping implements.

5. The dental floss and post-floss cleaning system in accordance with claim 1, wherein:
the dental floss and wiping implement dispenser includes a top wall defining a dispensing opening through which each of the floss-and-post-floss cleaning assemblies are individually withdrawn from the dispenser cavity.

6. The dental floss and post-floss cleaning system in accordance with claim 1, wherein:
the dental floss and wiping implement dispenser is formed as a dispensing carton with a top wall defining a dispensing opening through which the single-use wiping implements and corresponding precut dental floss strands are individually withdrawn from the dispensing carton; two pairs of opposing sidewalls; and a bottom wall, opposite the top wall.

7. The dental floss and post-floss cleaning system in accordance with claim 1, wherein:
the dental floss and wiping implement dispenser defines a dispensing opening;
each of the single-use wiping implements are discrete wiping implements sequentially disposed within the dispenser cavity and each said discrete wiping implement overlaps an adjacent discrete wiping implement to form a stack of discrete wiping implements; and
each of the discrete wiping implements having the corresponding pre-cut dental floss strand affixed thereto both within the dispenser cavity and upon withdrawal outside of the dispenser cavity.

8. The dental floss and post-floss cleaning system in accordance with claim 1, wherein:
the dental floss and wiping implement dispenser defines a dispensing opening; and
each of the single-use wiping implements are discrete wiping implements sequentially disposed within the dispenser cavity and each said discrete wiping implement is releasably attached directly to an adjacent discrete wiping implement such that a first discrete wiping implement, upon withdrawal through the dispensing opening, pulls a portion of a subsequent adjacent discrete wiping implement through the dispensing opening.

9. The dental floss and post-floss cleaning system in accordance with claim 1, wherein:
each of the floss-and-post-floss cleaning assemblies are interfolded in a stack within the dispenser cavity such that a leading wiping implement of the stack lifts a portion of an adjacent trailing wiping implement of the stack upon withdrawal of the leading wiping implement through a dispensing opening defined by the dental floss and wiping implement dispenser.

10. The dental floss and post-floss cleaning system in accordance with claim 1, wherein:
for each of the plurality of floss-and-post-floss-cleaning assemblies, the pre-cut dental floss strand is affixed to the single-use wiping implement by an adhesive.

11. The dental floss and post-floss cleaning system in accordance with claim 1, wherein:
each of the pre-cut dental floss strands removably affixed to the single-use wiping implement includes two opposing end portions; and one of the two opposing end portions is a free gripping end portion that is not attached to the single-use wiping implement

12. A dental floss and post-floss cleaning system comprising:
a plurality of floss-and-post-floss-cleaning assemblies;
a dental floss and cleaning sheet dispenser including a top wall defining a dispensing opening and configured to hold and dispense, through the dispensing opening, the plurality of floss-and-post-floss-cleaning assemblies, each of the plurality of floss-and-post-floss-cleaning assemblies including:
a discrete cleaning sheet made of a flexible and absorbent material; and
a corresponding pre-cut dental floss strand removably affixed to a middle portion of the discrete cleaning sheet, the plurality of floss-and-post-floss cleaning assemblies being arranged as a stack such that each discrete cleaning sheet, along with the affixed corresponding pre-cut dental floss strand, is sequentially removable from the dispenser through the dispensing opening,
wherein each of the pre-cut dental floss strands includes two opposing end portions, and one of the two opposing end portions is a free gripping end portion that is not attached to the middle portion of the discrete cleaning sheet.

13. The dental floss and post-floss cleaning system in accordance with claim 12, wherein:
the discrete cleaning sheet is one of a tissue paper and a gauze pad.

14. The dental floss and post-floss cleaning system in accordance with claim 12, wherein:
each of the plurality of floss-and-post-floss cleaning assemblies is arranged in a stack of discrete cleaning sheets such that each discrete cleaning sheet is disposed on top of an adjacent discrete cleaning sheet with one pre-cut dental floss strand between each discrete cleaning sheet.

15. The dental floss and post-floss cleaning system in accordance with claim 12, wherein:
each of the floss-and-post-floss cleaning assemblies are interfolded in a stack of discrete cleaning sheets such that a leading discrete cleaning sheet of the stack lifts a portion of an adjacent discrete cleaning sheet of the stack upon withdrawal of the leading discrete cleaning sheet through the dispensing opening.

16. The dental floss and post-floss cleaning system in accordance with claim 12, wherein:
for each of the plurality of floss-and-post-floss-cleaning assemblies, the pre-cut dental floss strand is affixed to the middle portion of the discrete cleaning sheet by an adhesive.

17. The dental floss and post-floss cleaning system in accordance with claim 12, wherein:
the dental floss and cleaning sheet dispenser is formed as a tissue box.

18. A dental floss and post-floss cleaning system comprising:
one of a tissue paper and a gauze pad with a pre-cut dental floss strand removably affixed to a middle portion of the one of a tissue paper and gauze pad via an adhesive; and
a dispensing body configured to dispense the one of the tissue paper and the gauze pad together with the adhered pre-cut dental floss strand,
wherein the pre-cut dental floss strand includes two opposing end portions, and one of the two opposing end portions is a free gripping end portion that is not attached to the one of the tissue paper and the gauze pad.

19. The dental floss and post-floss cleaning system in accordance with claim 18, wherein:
the dispensing body includes a dispensing carton defining a dispensing opening through which the one of the tissue paper and the gauze pad, together with the adhered pre-cut dental floss strand, is removable from the dispensing carton.

20. The dental floss and post-floss cleaning system in accordance with claim 19, wherein:
the dispensing carton houses a plurality of tissue papers or gauze pads each with the pre-cut dental floss strand removably affixed to the middle portion thereof, the plurality of tissue papers or gauze pads being arranged in a sequential stack within the dispensing carton so as to be sequentially and individually removable from the dispensing carton through the dispensing opening.
